(19) United States
(12) Patent Application Publication
(10) Pub. No.: US 2008/0186879 A1
(43) Pub. Date: Aug. 7, 2008

(54) Conferencing System Having a User Interface Compatible with a Variety of Communication Devices

(75) Inventors: Lindsey Cochran Bowman, Incline Village, NV (US); Michael Robert Malter, San Rafael, CA (US); Joshua David Wynd, El Cerrito, CA (US)

Correspondence Address: URIARTE LAW, 257 RODONOVAN DRIVE, SANTA CLARA, CA, 95051, US

(73) Assignee: Ripple Communications, Inc., Incline Village, NV (US)

(21) Appl. No.: 11/670,957

(22) Filed: Feb. 2, 2007

(51) Int. Cl. H04L 12/16

(52) U.S. Cl. 370/260

(57) ABSTRACT

Described is a conferencing system having a conference service, a Web-based service and an IP-telephony service, which enable the conferencing system to provide communication functions, such as conferencing and chat-room functionality, in response to at least one menu selection or menu navigation command received by a user interface. This user interface is comprised of components that render it compatible with a communications device that generates DTMF signals, such as a telephone or IP telephony-enabled client. These components may include an interactive voice response (IVR) module and a menu navigation module.

### BACKGROUND OF THE INVENTION

(1) Technical Field

The present invention relates to solutions for providing conferencing functionality through a user interface that is compatible with a variety of communication devices, including telephones and IP telephony-enabled devices.

(2) Description of the Related Art

Communication systems that provide voice conferencing or chat functionality to telephones are known. However, such systems rely on audio prompts or the user's memory to navigate through the menu used by such systems. Consequently, a need exists for an improved communication system that can support the use of telephones with such as systems but also IP telephony-enabled devices. Further, a need exists for a communication system that employs a user menu that can be used by telephones and IP telephony-enabled devices and that process a menu item selection command or a menu navigation command.

### BRIEF DESCRIPTION OF THE DRAWINGS

The accompanying drawings, which are incorporated in and form a part of this specification, illustrate embodiments of the present invention and, together with the description, serve to explain the principles of the invention.

FIG. 1 is a block diagram that includes an enhanced conferencing system having a user interface compatible with a variety of communication devices, including telephones and IP telephony-enabled devices in accordance with one embodiment of the present invention.

FIG. 2 is a block diagram of an IP telephony-enabled client in accordance with another embodiment of the present invention.

FIG. 3 is a block diagram of a conference service implementation in accordance with another embodiment of the present invention.

FIG. 4 is a block diagram illustrating the concepts of menu navigation and menu item selection through a menu structure utilized by an IVR module in accordance with yet another embodiment of the present invention.

FIG. 5 is a block diagram of a communications interface in accordance with yet another embodiment of the present invention.

FIG. 6 is a block diagram disclosing a method of operating a conferencing system having a selection menu compatible with different communication devices in accordance with another embodiment of the present invention.

### DETAILED DESCRIPTION OF THE EMBODIMENTS OF THE INVENTION

In the following detailed description, for purposes of explanation, numerous specific details are set forth to provide a thorough understanding of the various embodiments of the present invention. Those of ordinary skill in the art will realize that these various embodiments of the present invention are illustrative only and are not intended to be limiting in any way. Other embodiments of the present invention will readily suggest themselves to such skilled persons having benefit of this disclosure.

In addition, for clarity purposes, not all of the routine features of the embodiments described herein are shown or described. It is appreciated that in the development of any such actual implementation, numerous implementation-specific decisions must be made to achieve the developer's specific goals. These specific goals will vary from one implementation to another and from one developer to another. Moreover, it will be appreciated that such a development effort might be complex and time-consuming but would nevertheless be a routine engineering undertaking for those of ordinary skill in the art having the benefit of the herein disclosure.

Element numbers are used throughout this disclosure, including the drawings. The variable “n” is used to indicate a possible number of element instances in a particular example. In one embodiment of the present invention, n may be equal to or greater than two.

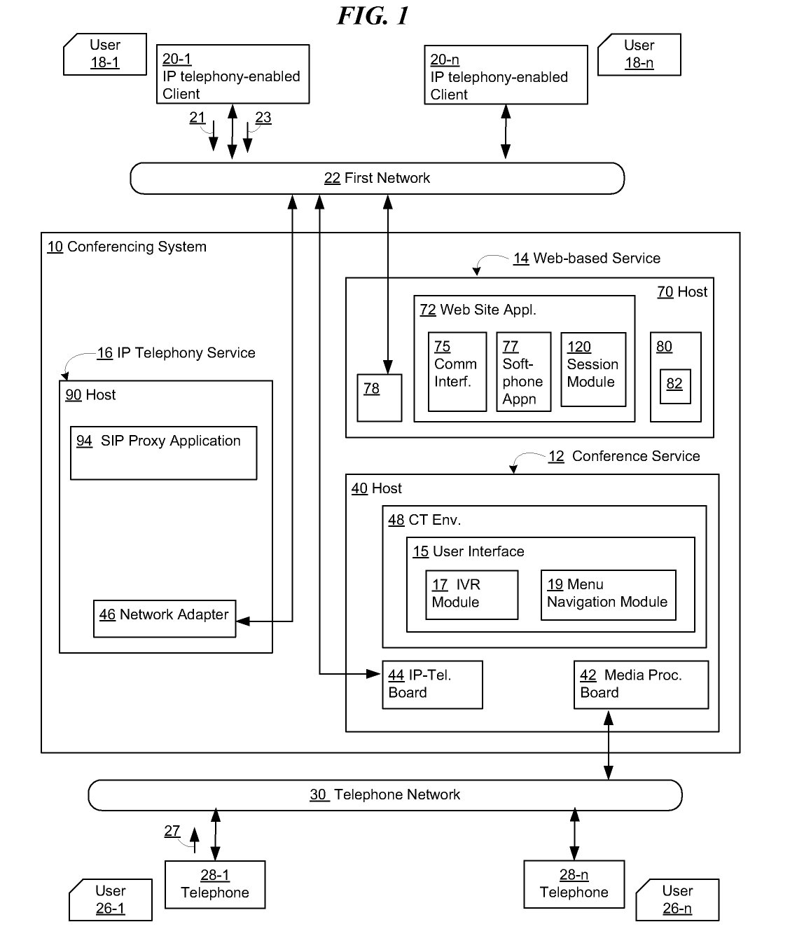

FIG. 1 illustrates a conferencing system 10 having a conference service 12, a Web-based service 14 and an IP-telephony service 16 in accordance with one embodiment of the present invention. Conference service 12, Web-based service 14 and IP telephony service 16 enable conferencing system 10 to provide communication functions, such as conferencing and chat-room functionality, in response to at least one menu selection or menu navigation command received by a user interface 15. User interface 15 is comprised of components that render the user interface compatible with a communications device that generates DTMF signals, such as a telephone or IP telephony-enabled client. These components may include an interactive voice response (IVR) module 17 and a menu navigation module 19, which are further described below.

Through user interface 15, conferencing system 10 responds to a menu item selection command 21 or a menu navigation command 23 made by at least one user, such as user 18-1 or 18-n, through a IP telephony-enabled device, such as IP telephony-enabled client 20-1 or 20-n, that is connected through a first network 22 and that has a communications interface compatible with user interface 15. Conferencing system 10 may also respond to a menu selection 27 made by another user, such as user 26-1 or 26-n, through another type of communication device, such as telephone 28-1 or 28-n, that is connected to a telephone network 30.

DTMF, sometimes referred to as dual-tone multi-frequency, is a standard used for telephone signaling and defined under Recommendation Q.23 by the ITU, hereinafter named “DTMF standard”. The DTMF standard is commonly known by those of ordinary skill in the art and defines certain DTMF signals with a set of numbers or characters. One commonly known DTMF device that generates DTMF signals is the keypad commonly found on telephones. The keypad includes keys associated with numbers and characters. Pressing a key causes the keypad to generate a DTMF signal defined under the DTMF standard for the number or character associated with the pressed key.

First network 22 is in the form of an area network, and may include a local area network (LAN), a metropolitan area network (MAN), a wide area network (WAN) or any combination of these networks. For example, first network 22 may be the Internet, which can be loosely defined as a group of interconnected packet-switched communication networks that respectively operate using a selected protocol, such as the TCP/IP protocol suite, the Open Systems Interconnection (OSI) protocol, data link protocols, such as the ATM protocol, or equivalent. First network 22 may also include routers, hubs, gateways, firewalls, modems, switches and the like (not shown). First network 22 permits conference service 12 to communicate with devices connected to first network, such as Web-based service 14, IP-Telephony service 16 and IP telephony clients 20-1 and 20n, while telephone network 30 permits conference service 12 to establish and receive telephone calls with telephones 28-1 and 28-n.

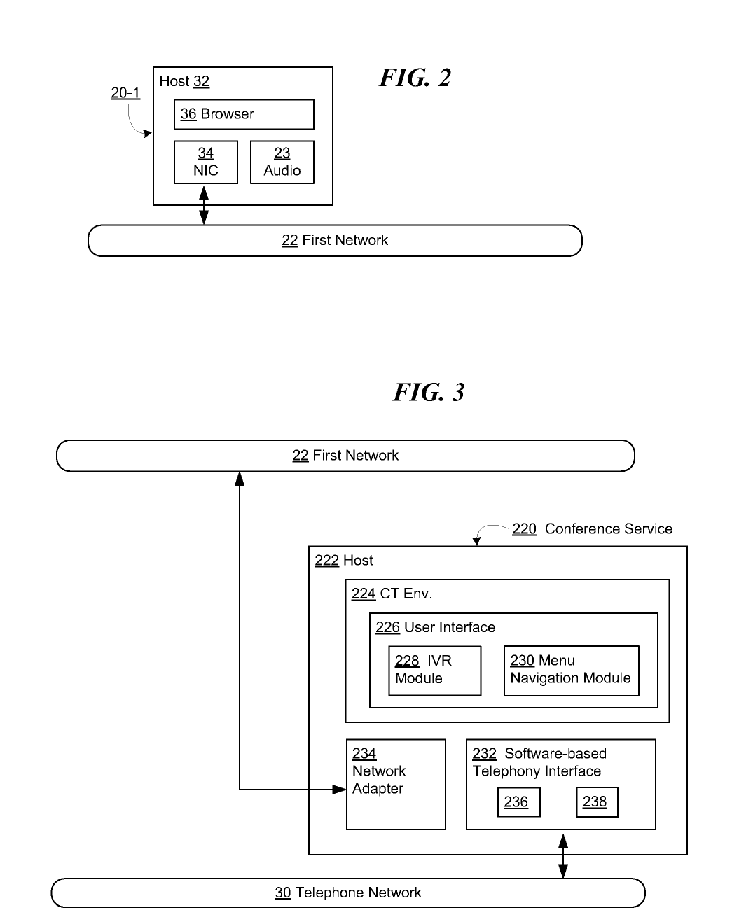

The term “IP telephony-enabled client” includes any computing device that can communicate with devices that can use the World Wide Web, named the “Web”. In the example disclosed in FIG. 1, the term Web includes first network 22. In the embodiment shown in FIG. 2, IP telephony-enabled client 20-1 may be implemented by using a host 32 that includes a network adapter 34 for enabling client 20-1 to connect to first network 22, audio functionality 33 and a Web browser 36. The term “host” includes a general purpose computer, server, portable computing device, such as a cell phone or PDA, or equivalent computing device having an operating system, mass storage device and appropriate user interfaces (collectively not shown), such as a video monitor, keyboard, keypad, pointing device, speaker, microphone or any combination of these user interfaces. The term “audio functionality” includes functionality that enables a host to send and receive audio signals.

The term “network adapter”, sometimes referred to as a network interface, network interface controller, sometimes referred to as a NIC, or network card, is intended to include a device for allowing a host to communicate over a network, such as first network 22. A network adapter typically complies with a physical and data link layer standard, such as the Ethernet networking standard, associated with the network intended for use with the network adapter.

Telephone network 30 may include a public switched telephone network (PSTN), a Plain Old Telephone System (POTS) network, or any combination of these. The terms PSTN and POTS are commonly known by those of ordinary skill in the art and typically used to interconnect telephones, telephone-compatible devices, and equipment supporting the use of these devices on PSTN and POTS.

In FIG. 1, conference service 12, Web-based service 14 and IP telephony service 16 may be implemented by using a host configured to have the functionality described herein. For example, conference service 12 may include a host 40, media processing board 42, IP-telephony board 44, a computer telephony run-time environment, named “CT environment”, 48 and user interface 15, which includes IVR module 17 and menu navigation module 19. Host 40, CT environment 48, media processing board 42, IP-telephony board 44 and user interface 15 enable conference service 12 to provide communication services, such as conferencing and chat functionality, to users logged onto conference service 12 through either a IP telephony-enabled client or through a telephone, such as user 20-1 or user 18-1, respectively. In the embodiment shown in FIG. 2, host 40 may be implemented by using a computer server, having model I-2000 R5 from Alliance Systems, Inc of Plano, Tex., that is installed with a suitable operating system, such as Windows 2003 Server R2 (not shown).

The term “media processing board” is intended to include a device for integrating a host with a telephone and for providing telephone-related functionality, such as DTMF generation and tone detection, caller ID, DNIS (Dialed Number Identification Service), storing and processing an audio signal, telephone conferencing, interactive voice response functionality, or any combination of these functions. Media processing board 42 provides a platform for integrating host 40 with at least one telephone, such as telephone(s) 28-1, 28-n or both, through a telephone network, such as telephone network 30 in FIG. 1. Media processing boards are known and readily available. For example, a media processing board having model number NetStructure® DM/V480A, sometimes referred to as a “Dialogic Board”, from Dialogic Corporation, hereinafter named “Dialogic”, of Montreal, Quebec, Canada, may be used to implement media processing board 42.

IVR module 17 includes programming scripts that enable media processing board 42 to provide audio prompts that describe a selected menu structure to a user who is logged onto conferencing system 10 through an applicable communication device, as a telephone connected to conference system 10 via conference service 12 or through a IP telephony-enabled client connected to conference system 10 via Web-based service 14. In accordance with one embodiment of the present invention, the programming scripts are written using a proprietary development environment, named Envox CT ADE and available from Envox Corporation of Westborough, Mass. Using Envox CT ADE is not intended to be limiting to the various embodiments disclosed herein. Other development tools may be used, as well as programming languages. For example, the programming scripts used may be composed by using the VoiceXML or CCXML programming language. VoiceXML and CCXML are industry standards defined by the World Wide Web Consortium, sometimes referred to as the “W3C”.

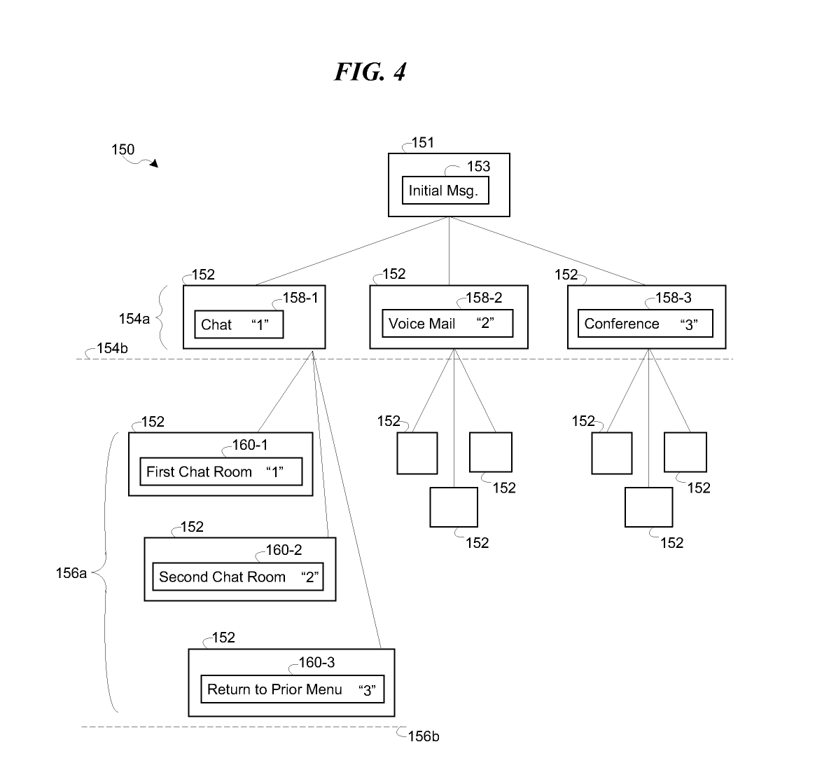

The audio prompts describe selectable menu items from a menu structure defined for conference system 10. For example, referring to FIG. 4, a menu structure 150 may be arranged as a menu tree having linked nodes 152. Each audio prompt describes at least one menu item within menu structure 150 and a number or character associated with each menu item described during the audio prompt. Each audio prompt represents a layer in the menu tree and each menu item described by the audio prompt represents a node on that layer. Menu structure 150 may be implemented to have a root node 151, which can be used to represent an initial audio prompt 153 on menu structure 150 that begins after a user, such as user 18-1, logs onto conference system 10. For example, initial audio prompt 153 may include an audio message that notifies user 18-1 that the user has successfully logged-on conference system 10.

First audio prompt 154a may represent a menu layer 154b, while second audio prompt 156a may represent a menu layer 156b that can be entered into through menu layer 154b. First audio prompt 154a describes menu items 158-1, 158-2 and 158-3, and second audio prompt 156a describes menu items 160-1, 160-2 and 160-3. Each user can navigate the menu tree by selecting a node. Since a menu item represents a node in the menu tree, selecting a menu item selects a node. Each menu item selection may lead to an event associated with the menu item, such as entering into a chat session in menu item 158-1 or a conference session in menu item 158-n. In addition, depending on the menu item selected, the selection may trigger another audio prompt that describes another set of menu items, such as joining a particular chat room 160-1 or 160-2, or a menu navigation command, such as a command 160-3 to return to the previous menu level.

To select a menu item provided by an audio prompt includes selecting the number or character assigned to the menu item by using a telephone keypad or a communications interface 75. Each audio prompt describes the particular association of each number or character to a particular menu item. The assignment of characters and numbers to menu items is not intended to be limiting although the numbers or characters selected may be limited to a set of numbers and characters that are typically found on a DTMF standards-compliant keypad, such as the keypad found on a typical telephone. This set of numbers and characters may include the numbers zero through nine, the asterisk symbol “*” and the pound symbol “#. Each number or character is unique to a menu item for each layer but the number or character can be used in another layer in the menu tree. To reach a node directly below an upper node, the user would select the upper node and then the node directly below the upper node sequentially, with or without prompting. The number and sequence of menu selections, hereinafter named “selection sequence”, required to reach a desired menu item depends on the location of the menu item in the menu structure.

Menu items 158-1 through 158-3, inclusive, are respectively assigned to DTMF keys one (“1”), two (“2”) and three (“3”), while menu items 160-1 through 160-3 are respectively assigned to DTMF keys one (“1”) and two (“2”) and pound symbol (“#”). To reach menu item 160-2, which is associated with entering a second chat room, requires a selection sequence that includes the DTMF keys one (“1”) and two (“2”) since menu items 158-1 and 160-2 respectively correspond to the numbers assigned to the menu items that would be required to navigate to menu item 160-2 on menu structure 150. In another example, to reach menu item 160-1, requires a selection sequence that includes selecting the DTMF key (“1”) twice in sequence. After selecting menu item 160-1, a user may select menu item 160-3 by hitting the DTMF key pound symbol (“#”), which causes IVR module 17 to return the user to menu layer 154b and to generate the audio prompt associated with menu items 158-1 through 158-3.

Menu navigation module 19 receives the DTMF signals that represent the menu selections transmitted by a communication device before these DTMF signals are processed by CT environment 48 and IVR module 17. For each DTMF signal received from a communication device, menu navigation module 19 determines whether the signal corresponds to a pre-selected DTMF key, named “prefix”, such as the DTMF key “A”. If menu navigation module 19 receives this prefix, it buffers subsequent DTMF signals until it receives another pre-selected character, named “suffix”, such as the DTMF key “D”. Upon receiving this suffix, menu navigation module 19 sends to CT environment 48 the DTMF signals that are received after the prefix but before the suffix and that correspond to the same communication device. Menu navigation module 19 also notifies CT environment 48 that the DTMF signals form a selection sequence. CT environment 48 uses the selection sequence to navigate through menu structure 150 defined for IVR module 17 and causes the functionality of the last menu item in the selection sequence to be provided to the communication device. In accordance with one embodiment of the present invention, the prefix and suffix keys selected are DTMF keys that are not used to represent a menu item in the menu structure used by IVR module 17. The prefix and suffix DTMF keys are also translated into DTMF signals as defined under the DTMF standard.

In the embodiment shown in FIG. 1, these DTMF signals may be sent by a IP telephony-enabled client on the same communication stream used for sending conferencing or chat data, such as a voice stream. However, this approach is not intended to be limiting in any way. A second communication path or a separate channel may also be used and may be dedicated for sending menu commands. From example, host 40 may have be implemented to use at least two IP addresses with the first IP address used for sending voice stream data, while the second IP address is used for sending menu navigation commands, menu item selection commands or both that are generated by the IP telephony-enabled client.

The term “IP-telephony board” is a device for integrating an IP telephony-enabled device that can conduct IP telephony functions through an applicable network, such as first network 22. IP telephony, sometimes referred to as Voice Over IP, functionality may be provided using a standard IP telephony protocol, such as SIP or H.323. SIP (Session Initiation Protocol) or the H.323 standard is commonly used in networks that support IP telephony functionality. The SIP and H.323 standards are commonly known, and are thus, not further described herein. In the example shown, IP-telephony board 44 provides SIP gateway functionality, including routing IP telephony traffic between first network 22 and CT environment 48. IP-telephony board 44 may be implemented using the DM3 IPLink board, also available from Dialogic . . .

The term CT environment may include a computer telephony development environment for developing a communication application for interacting with computer telephony-related APIs (application programming interfaces), such as APIs available from Dialogic. These communication applications may include interactive voice response, conferencing and other telephony-based solutions. An API is an abstraction layer that permits an application, such as a computer program, to interact with or use another application or computing device, such as a telephony board, media processing board, host or equivalent, program functions, libraries and the like. The term interaction includes exchanging data, sending or receiving requests, sending or receiving data, accessing program functions or similar acts.

Using media processing board 42 and IP-Telephony board 44 is not intended to limit the embodiment described with reference to FIG. 1. For example, referring now to FIG. 3, a conference service 220 may be used as part of conferencing system 10 by coupling conference service 220 with first network 22 and telephone network 30. Conference service 220 may be implemented using a host 222, a CT environment 224 and a user interface 226 having an IVR module 228 and a menu navigation module 230. Host 222, CT environment 224, user interface 226, IVR module 228 and menu navigation module 230 may be implemented in substantially the same form and function as described herein for host 40, CT environment 48, user interface 15, IVR module 17 and a menu navigation module 19. However, unlike conference service 12, conference service 220 includes a software-based telephony interface 232 and a network adapter 234. Software-based telephony interface includes host media processing software 236 and a telephone network adapter 238.

When used with network adapter 234 and operating on host 222, media processing software 236 provides SIP gateway functionality by routing IP telephony traffic, which is generated by users of conferencing system 10, between first network 22 and CT environment 224. In effect, when executing on host 222, media processing software 236 provides substantially the same functionality as described for IP-telephony board 42. Host media processing software 236 may be implemented using host media processing software r3.0 product, which is available from Dialogic.

In addition, when used with telephone network adapter 238 and executing on host 222, media processing software 236 provides substantially the same function as described previously for media processing board 42. Telephone network adapter 238 provides a physical and electrical interface between host 222 and telephone network 30, permitting telephone-based communication signals to be transmitted between conference service 220 and a telephone (not shown) coupled to telephone network 30. Telephone network adapter 238 may be implemented using a thin blade product available from Dialogic.

IP-telephony service 16 may be implemented by using a host 90 that includes a network interface controller or NIC 92 for interfacing host 90 to first network 22 and a SIP proxy application 94 that provides SIP call set-up and signaling functionality to clients seeking to use the communication functionality provided by communication system 10. Host 90 may be implemented by using any suitable computer system, such as the computer server and operating system previously described for use in implementing host 40 above. SIP proxy application 94 may be implemented by the Entice Session Controller from Emergent® Network Solutions, L.P. of Allen, Tex. SIP proxies are known by those of ordinary skill in the art and the use of the Entice Session Controller is not intended to limit the present invention in any way. Other types and models of SIP proxies may be used.

Web-based service 14 may be implemented by using a host 70 that includes a Web site application 72, which provides a communications interface 75 and a softphone client application 77 to an IP telephony-enabled client, such as IP telephony-enabled client 20-1, that is logged onto Web-based service 14. Upon receiving communications interface 75 and softphone application 77, IP telephony-enabled client 20-1 displays communications interface 75 through Web browser 36. Communications interface 75 is functionally coupled to softphone application 77 through the application programming interface used by softphone application 77.

Softphone application 77 provides IP telephony functionality to a computing device, such as IP telephony-enabled client 20-1. Softphone applications, computing devices, operating systems and Web browsers are known and are thus, not further described herein. In accordance with one embodiment of the presenting invention, softphone application 77 is implemented using the product named SIPphone (Active X) from Microappliances.com, Inc. of Palo Alto, Calif., hereinafter “Microappliances”. Using SIPphone (Active X) requires a user agent, such as a Web browser, that supports Active X. SIPphone (Active X) is commonly known and available, and is supported by the Microsoft® Internet Explorer Web browser. In addition, although softphone application 77 is depicted as locally stored on host 70, in another embodiment, Web site application 72 may include program code that provides softphone application 77 to IP telephony-enabled client 20-1 from a third party Web site maintained by a provider of softphone application 77, rather than directly from host 70.

Host 70 may be implemented by using the same computer system and operating system that were used to implement host 40 above. Host 70 also includes a network adapter 78 for interfacing host 70 to first network 22 and a data store 80 for storing user information 82, such as personal and logon information, contact information, billing information and the like. Web site application 72 may be implemented by using a suitable Web server application that can deliver Web pages and other Web content through first network 22 to the IP telephony-enabled client. For example, Web site application 72 may be implemented by using Windows Internet Information Service, named IIS, with Windows 2003 Server as the operating system. The use of IIS and the Windows 2003 operating system is not intended to limit this embodiment of the present invention in any way. Other types of Web server applications and operating systems may be used. For example, Apache, which is an open source Web server application available from the Apache Software Foundation, and Mandriva Linux may be used in lieu of IIS and Windows 2003, respectively.

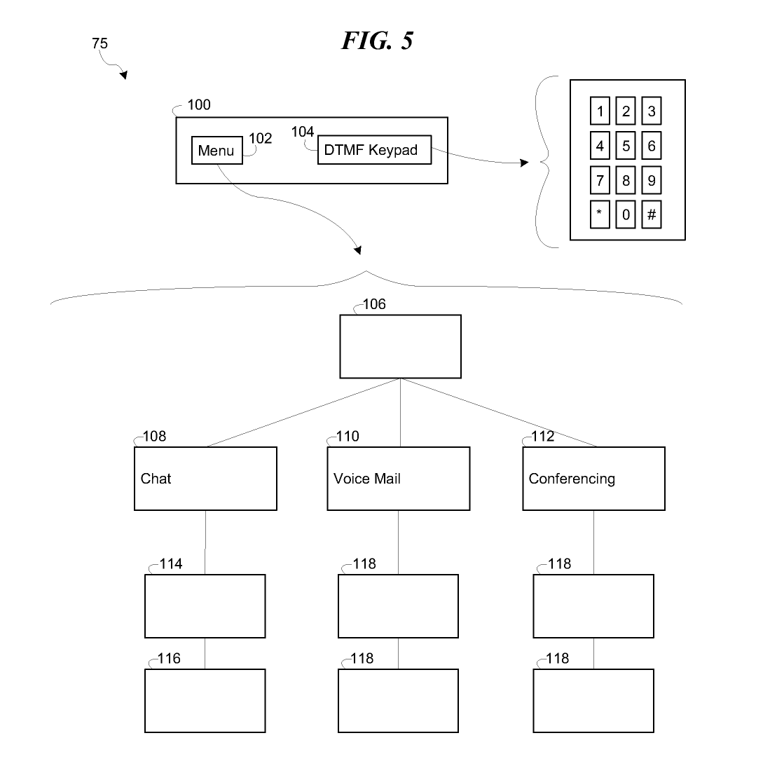

The example shown in FIG. 5 is not intended to be limited to using Internet Explorer or the Microappliances SIPphone. Web browsers and softphone applications are commonly known and available, and any Web browser or softphone application may be used as long as they are compatible with each other and can be used with communication system 10, as described herein.

Communications interface 75 includes Web page content and program code that enables a user of an IP telephony-enabled client that is logged onto a Web-based service to obtain communication functionality provided by a conferencing system. For example, as illustrated in FIG. 5, communications interface 75 may include a Web page 100 that displays a representation of a menu 102 and a keypad 104 when Web page 100 is launched on the IP telephony-enabled client. The user may use either screen menu 102 or keypad 104 to obtain communication functionally from the conferencing system. As described with respect to FIG. 1, the user may include user 18-1 who is using IP telephony-enabled client 20-1 to log onto Web-based service 16 in order to obtain communication functionality provided by conferencing system 10, while the menu structure and IVR module may be implemented in the manner described for menu structure 150 and IVR module 17.

Screen menu 102 includes menu items 106 that are equivalent to the menu items defined in menu structure 150 that is used by media processing board 42 and IVR module 17 in conference service 12. For example, screen menu 102 may include the following menu items: chat 108, voice mail 110 and conferencing 112. Chat 108 includes menu items 114 and 116 that represent chat rooms that may be joined by user 18-1. Voice mail 110 and conferencing 112 may also include additional menu items 118, which are not specifically described to avoid overcomplicating the herein disclosure. Additional menu items 18 may represent the menu items that correspond to the functionality provided by the menu items that correspond to voice mail 110 and conferencing 112 and that mirror the functionality of menu items in menu structure 150 which pertain to voice mail and conferencing functionality, such as menu items 158-2 and 158-3.

User 18-1 may directly select a menu item displayed and is neither required to navigate through menu layers defined within menu structure 150 nor needs to respond to audio prompts provided by conference service 12. Consequently, in the embodiment shown, screen menu 102 may be configured without menu items that represent navigation commands, such as a command to return to a previous menu.

Selecting a menu item from screen menu 102 causes Web page 100 to generate the same selection sequence that would have been required if a DTMF keypad or equivalent had been used to select a menu item from menu structure 150. Web page 100 generates the selection section without waiting for an audio prompt to describe menu items for each menu layer above the menu item selected by user 18-1 in menu structure 150. Web page 100 translates the number(s), character(s) or any combination of the symbols that are defined in the selection sequence into DTMF signals. In addition, each selection sequence generated is preceded by a prefix key and suffix key that match the DTMF prefix and suffix keys used by menu navigation module 19 to flag selection sequences. In accordance with the embodiment described in FIG. 5, the prefix selected is the letter “A” and the suffix selected is the letter “D”. The prefix and suffix are also translated into DTMF signals as defined under the DTMF standard. Menu navigation module 19 process the DTMF signals bounded by the prefix and suffix in the manner previously described, including providing the DTMF signals representing the selection sequence to media processing board 42.

Keypad 104 includes a set of selectable numbers and characters that are typically found on a DTMF standards-compliant keypad, such as the keypad found on a common telephone, including the numbers zero through nine, the asterisk symbol, “*”, and the pound symbol “#”. Unlike screen menu 102, selecting a key on keypad 104 generates a DTMF key signal corresponding to the key selected. Keypad 104 operates in a similar fashion to that of a standard telephone keypad, except that the Web page 100 transmits the DTMF key signal generated to IVR module 17 through network 22 by using softphone application 77. Since the DTMF key signal does not include the prefix and suffix navigation flags, menu navigation module 19 passes the DTMF signal directly to media processing board 42, which processes each DTMF key signal by using menu structure 150 to the interactive voice response to provide to user 18-1.

By providing a screen menu 102 and keypad 104, Web page 100 provides a user, such as user 18-1, two methods of selecting conferencing functionality offered by conferencing system 10. The use of both screen menu 102 and keypad 104 is not intended to be limiting. Either screen menu 102 or keypad 104 may be without the other.

Referring again to FIG. 1, communications interface 75 also includes a session module 120 that provides program code that manages a logon routine for permitting a user, such as user 18-1, to logon to conferencing system 10 via Web-based service 14. If user 18-1 successfully logs onto conferencing system 18, session module 120 also causes communications interface 75 to send a session request to IP telephony service 16. The session request includes the logon-id and the user profile of user 18-1. In accordance with one embodiment of the present invention, the session request has a format that complies with implemented the type of VOIP protocol used by conferencing system 10. For example, if conferencing system 10 is configured to operate to use the SIP standard as its VOIP protocol, session module 120 is configured to generate a session request that also complies with the SIP standard.

Upon receiving the session request, IP telephony service 16 through SIP proxy application 94 attempts to authenticate the session request and if it is successful, SIP proxy application 94 identifies a host, such as host 40, from conference service 12 that can support the session request. IP telephone service 16 includes a database (not shown) of information related to users that have previously registered with conferencing system 10. IP telephony service uses this information when authenticating a session request. In addition, SIP proxy application 94 may be configured by an administrator of conference system 10 with respective IP addresses of each host, such as host 40, that comprises conference service 12.

If SIP proxy application 94 successfully authenticates the session request, it selects a host from conference service 12 that can support the session request and generates a session reply, which is then transmitted by IP telephony service 16 to the session module that sent the session request, which in this example is session module 120 of IP telephony-enabled client 20-1. The session reply includes the IP address of the host that is selected by SIP proxy application as a host suitable for supporting the session request.

If session module 120 receives from IP telephony service 16 a session reply that approves the request, session module 120 causes IP telephony-enabled client through softphone application 77 to establish a communication path with IP telephony board 44 of conference service 12 through first network 22. In accordance with one embodiment of the present invention, the communication path may be established using the Real Time Protocol, sometimes referred to as RTP.

Besides sending a session request, IP telephony-enabled client 20-1 through session module 120 may also send conferencing information to conference service 12. Conferencing information may include a category, such as a group of users, to which conference service 12 may extend the communication path just established, enabling user 18-1 to communicate with this group of users through IP telephony-enabled client 20-1 through Web page 100.

In accordance with one embodiment of the present invention, communications interface 75 includes static and dynamic Web page content and program code developed using the ASP.net development platform from Microsoft although the use of this development platform is not intended to be limiting in anyway.

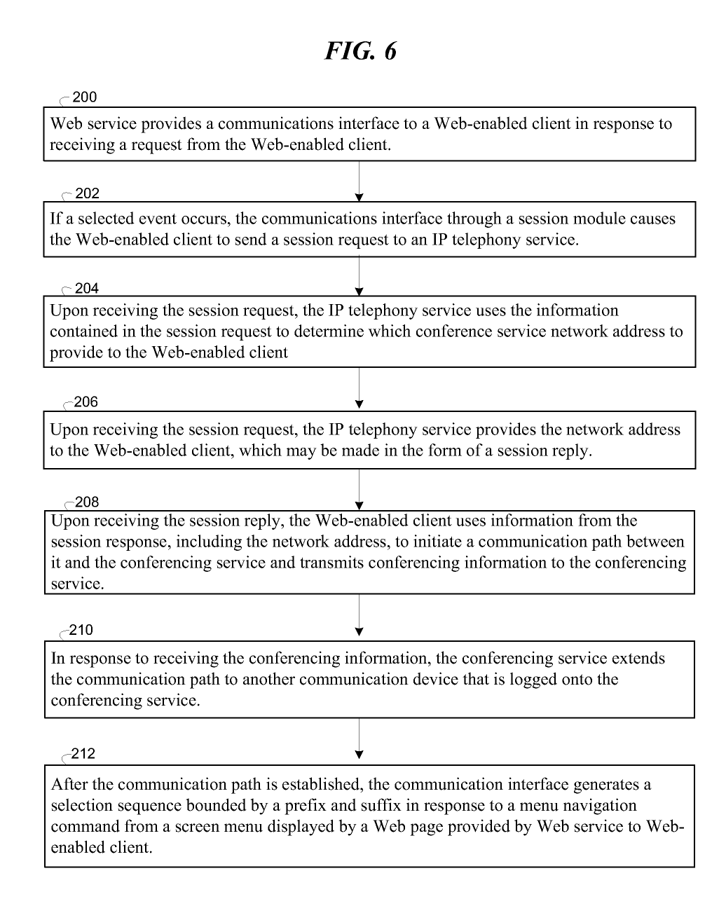

Referring now to FIG. 6, a method of providing conferencing services to at least one IP-telephony client connected to a first network and at least one telephony device connected to a second network is disclosed in accordance with another embodiment of the present invention.

A web-based service provides 200 a communications interface to an IP telephony-enabled client.

If a selected event, such as when a user successfully logs onto the Web-based service, occurs, the communications interface through a session module causes 202 the IP telephony-enabled client to send a session request to an IP telephony service.

Upon receiving the session request, the IP telephony service uses the information contained in the session request to determine 204 which conference service network address to provide to the IP telephony-enabled client and provides 206 the network address to the IP telephony-enabled client, which may be made in the form of a session reply. The IP telephony service may also authenticate and account for the user's use of conferencing system 10.

Upon receiving the session reply, the IP telephony-enabled client uses information from the session response, including the network address, to initiate 208 a communication path between it and the conference service, and transmits conferencing information to the conference service.

In response to receiving the conferencing information, the conference service extends 210 the communication path to another communication device that is logged onto the conference service, enabling the user of the communication device to communicate in real-time with other users who are also logged onto the conference service and who are using a communication device on the same communication path.

After the communication path is established, the communication interface generates 212 a menu navigation command, which includes a selection sequence bounded by a prefix and suffix, in response to a menu item selection made from a screen menu displayed by a Web page provided by a Web-based service to an IP telephony-enabled client.

While the present invention has been described in particular embodiments, it should be appreciated that the present invention should not be construed as limited by such embodiments. Rather, the present invention should be construed according to the claims below.

We claim:

1. A conferencing system having a selection menu compatible with different communication devices, which includes an IP telephony-enabled device, the system comprising:
a conference service having an IP-telephony application and a first network interface for connecting to a first network;
a web service for providing a communications interface to the IP telephony-enabled device in response to receiving a request from the IP telephony-enabled device, said web service for connecting to said first network, and said communications interface including a session module for causing said communications interface to send a session request in response to a selected event;
an IP-telephony service for connecting to said first network and for generating a session reply in response to receiving said session request;
wherein the IP telephony-enabled device uses information from said session response to initiate a communication path between the IP telephony-enabled device and said conference service and to transmit conferencing information to said conference service;
wherein, in response to receiving said conferencing information, said conference service extends said communication path to a first communication device that is logged onto said conference service via said telephone network;
wherein said communications interface includes a means for displaying a screen menu on the IP telephony-enabled device and a means for sending a menu item selection command or a menu navigation command, said screen menu having a plurality of menu items; and
wherein the conferencing system provides communication functions to the IP telephony-enabled device in response to said menu item selection command.

2. The system of claim 1, wherein said menu navigation command includes a sequence of menu item selections, said menu navigation command including at least two alphabetical DTMF keys.

3. The system of claim 1, wherein said alphabetical DTMF keys includes an “A” DTMF key.

4. The system of claim 1, wherein said alphabetical DTMF keys includes a “D” DTMF key.

5. The system of claim 1, wherein:
at least one of said alphabetical DTMF keys is used as a prefix; and
said means for displaying a screen menu and said means for sending are implemented using program code and at least one Web page.

6. The system of claim 1, wherein said conference service includes a computer telephony environment that includes a user interface, said user interface including a menu navigation module that interprets a sequence of DTMF keys as a menu navigation command if said sequence begins with a prefix and ends with a suffix.

7. The system of claim 6, wherein said prefix represents a DTMF key “A” and said suffix represents a DTMF key “D”.

8. The system of claim 6, wherein:
said computer telephony environment further includes an IVR module;
said user interface informs said computer telephony environment that said sequence of DTMF keys represent a sequence of menu item selections if said user interface interprets said sequence as a menu navigation command; and
said computer telephony environment uses said sequence to navigate through a menu structure defined for said IVR module.

9. The system of claim 1, wherein:
said conference service further includes a telephony application and a second network interface for connecting to said telephone network; and
said conference service receives said telephone number from a Dialed Number Information Service if said communication device is a telephone.

10. The system of claim 1, wherein:
said IP telephony-enabled device includes a host having a user agent, said user agent having IP telephony functionality; and
said means for sending sends said menu navigation command through a second communication path.

11. The system of claim 10, wherein said IP telephony functionality is provided by an IP telephony softphone application that is compatible with at least one voice over IP protocol.

12. The system of claim 11, wherein said voice over IP protocol, includes any one protocol from of a comprising SIP and H.323.

13. The system of claim 1, wherein said first network includes a TCP/IP network and said second network includes a telephone network.

14. The system of claim 1, wherein said communication path is implemented using RTP and said means for sending sends said menu navigation command through said communication path.

15. A method of providing conferencing services to at least one IP-telephony client connected to a first network and at least one telephony device connected to a second network, said services provided by a conferencing system having a conference service, a web-based service and an IP-telephony service, the method comprising:
providing a communications interface to an IP-telephony client, said communications interface including a means for sending a session request to an IP telephony service;
providing a session reply to said IP-telephony client upon receiving said session request from said first IP-telephony client;
creating a communication path between the conference service and said IP-telephony client, said communication path including a network address received in said session response;
extending said communication path to at least one telephony device logged onto the conference service; and
generating a menu navigation command in response to a menu item selection made in reference to a screen menu displayed by a Web page provided by the Web-based service to said IP-telephony client.

16. The method of claim 15, wherein said providing a communications interface includes providing at least one Web page for enabling a user of said IP-telephony to select a menu item from said screen menu.

17. The method of claim 15, further including:
establishing a second communication path; and
sending said menu navigation command sequence through said second communication path.

18. The method of claim 15, wherein said menu navigation command includes a selection sequence bounded by a prefix and a suffix.

19. The method of claim 15, further including determining whether said menu item selection made from said screen menu is said menu navigation command or a menu item selection command.
The method of claim 15, further including determining whether said menu item selection made from said screen menu is said menu navigation command or a menu item selection command by determining whether said conference service receives a selection sequence that includes a predetermined prefix and suffix.

20. A conferencing system having a selection menu compatible with different communication devices, which includes an IP telephony-enabled device, the system comprising:
a conference means having an IP-telephony application and a first network interface for connecting to a first network;
a web service means for providing a communications interface to the IP telephony-enabled device in response to receiving a request from the IP telephony-enabled device, said web service means for connecting to said first network, and said communications interface including a means for causing said communications interface to send a session request in response to a selected event;
an IP-telephony service means for connecting to said first network and for generating a session reply in response to receiving said session request;
wherein the IP telephony-enabled device uses information from said session response to initiate a communication path between the IP telephony-enabled device and said conference means and to transmit conferencing information to said conference means;
wherein in response to receiving said conferencing information, said conference means extends said communication path to a first communication device that is logged onto said conference means via said telephone network;
wherein said communications interface includes a means for displaying a screen menu on the IP telephony-enabled device and a means for sending a menu item selection command or a menu navigation command, said screen menu having a plurality of menu items; and
wherein the conferencing system provides communication functions to the IP telephony-enabled device in response to said menu item selection command.

21. The system of claim 20, wherein said menu navigation command includes a sequence of menu item selections, said menu navigation command including at least two alphabetical DTMF keys.

22. The system of claim 20, wherein said alphabetical DTMF keys includes an “A” DTMF key.

23. The system of claim 20, wherein said alphabetical DTMF keys includes a “D” DTMF key.

24. The system of claim 20, wherein:
at least one of said alphabetical DTMF keys is used as a prefix; and
said means for displaying a screen menu and said means for sending are implemented using program code and at least one Web page.

25. The system of claim 20, wherein said conference means includes a computer telephony environment that includes a user interface means, said user interface means including a means for interpreting a sequence of DTMF keys as a menu navigation command if said sequence begins with a prefix and ends with a suffix.

26. The system of claim 25, wherein said prefix represents a DTMF key “A” and said suffix represents a DTMF key “D”.

27. The system of claim 25, wherein:
said computer telephony environment further includes a means for providing an interactive voice response;
said user interface means for informing said computer telephony environment that said sequence of DTMF keys represent a sequence of menu item selections if said user interface interprets said sequence as a menu navigation command; and
said computer telephony environment uses said sequence to navigate through a menu structure defined for said means for providing an interactive voice response.

28. The system of claim 20, wherein:
said conference means further includes a telephony application and a second network interface for connecting to said telephone network; and
said conference means for receiving said telephone number from a Dialed Number Information Service if said communication device is a telephone.

29. The system of claim 20, wherein:
said IP telephony-enabled device includes a host having a user agent, said user agent having IP telephony functionality; and
said means for sending sends said menu navigation command through a second communication path.

30. The system of claim 10, wherein said IP telephony functionality is provided by an IP telephony softphone application that is compatible with at least one voice over IP protocol.

31. The system of claim 30, wherein said voice over IP protocol, includes any one protocol from of a comprising SIP and H.323.

32. The system of claim 20, wherein said first network includes a TCP/IP network and said second network includes a telephone network.

33. The system of claim 20, wherein said communication path is implemented using RTP and said means for sending sends said menu navigation command through said communication path.
